(19) United States
(12) Patent Application Publication
(10) Pub. No.: US 2005/0228993 A1
(43) Pub. Date: Oct. 13, 2005

(54) Method and apparatus for authenticating a user of an electronic system

(76) Inventors: Kelan C. Silvester, Portland, OR (US); Francis X. McKeen, Portland, OR (US); Sundeep M. Bajikar, Santa Clara, CA (US); Luke E. Girard, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/823,067

(22) Filed: Apr. 12, 2004

(51) Int. Cl. H04L 9/00

(52) U.S. Cl. 713/168

(57) ABSTRACT

A user-authentication sub-system and approach for user authentication. The user authentication sub-system of one aspect includes at least a first input mechanism to receive first multi-factor authentication data associated with Z authentication factors, a cryptographic engine to encrypt the first multi-factor authentication data, and a separated user authentication, non-volatile data store to store the encrypted first multi-factor authentication data. The sub-system further includes a processing unit to determine whether second authentication data received via the at least first input mechanism matches a subset of the first multi-factor authentication data, the second authentication data associated with N authentication factors where N is less than or equal to Z.

### BACKGROUND

An embodiment of the present invention relates to the field of electronic systems and, more particularly, to a method and apparatus for user authentication.

Security continues to be an important concern related to computing, in the context of both protecting stored data and protecting data transmissions. For many applications and computing system uses, for example, it is important to verify user identity to be able to control access to personal computer and/or enterprise resources. Other types of systems such as wireless telephones, personal digital systems and the like may also benefit from the ability to verify user identity for various uses.

A variety of approaches are currently being used to verify user identity prior to enabling access to electronic system resources and/or capabilities. Some of these include simple password protection, encrypted passwords, etc. For some environments and applications, however, conventional user identity verification approaches may not provide sufficient security. In particular, many existing authentication approaches may be prone to mechanical, electrical or logical software attacks.

### BRIEF DESCRIPTION OF THE DRAWINGS

The present invention is illustrated by way of example and not limitation in the figures of the accompanying drawings in which like references indicate similar elements, and in which:

FIG. 1 is a high-level block diagram of an exemplary computing system via which the user authentication capabilities of some embodiments may be implemented.

FIG. 2 is a flow diagram showing a method of one embodiment for enrolling a user in a system such as the system of FIG. 1.

FIG. 3 is a flow diagram showing a method of one embodiment for authenticating a user.

FIG. 4 is a flow diagram showing a method of one embodiment for a requester to validate a user authentication sub-system.

### DETAILED DESCRIPTION

A method and apparatus for authenticating a user of an electronic system is described. In the following description, particular components, software modules, systems, etc. are described for purposes of illustration. It will be appreciated, however, that other embodiments are applicable to other types of components, software modules and/or systems, for example.

In order to keep data protected, both on the computing system itself and when transmitted across a communication link, user identity should be verified before access is granted to computing system and/or enterprise resources. A trusted and secure approach to user authentication in accordance with various embodiments includes a trusted sub-system for user authentication that supports multiple factors of authentication covering at least a subset of “what you have,” what you know,” and “what you are” as described below.

For one embodiment, a user authentication sub-system includes at least a first input mechanism to receive first multi-factor authentication data associated with Z authentication factors. The first multi-factor authentication data is used to identify a user and may include biometric authentication data for some embodiments. A cryptographic engine is further included to encrypt the first multi-factor authentication data and a separated, user authentication, non-volatile data store is coupled to the cryptographic engine to store the encrypted first multi-factor authentication data.

A processing unit coupled to the separated, user authentication, non-volatile data store is included to determine whether second authentication data received via the at least first input mechanism matches a subset of the first multi-factor authentication data, the second authentication data being associated with N authentication factors, where N is less than or equal to Z. Access to system resources may be granted or denied based on whether the second data is determined to match a subset of the first data.

Further details of these and other embodiments are provided in the description that follows.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

Embodiments of the invention may be implemented in one or a combination of hardware, firmware, and software. Embodiments of the invention may also be implemented in whole or in part as instructions stored on a machine-accessible medium, which may be read and executed by at least one processor to perform the operations described herein. A machine-accessible or machine-readable medium may include any mechanism for storing or transmitting information in a form readable by a machine (e.g., a computer). For example, a machine-accessible medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

In the description that follows, the terms protected, secure or trusted areas or paths may refer to areas of a device or paths between devices that have sufficient protections associated with them to prevent access to them by unauthorized devices and/or software. Further, the terms trusted software or code may refer to software that has been validated through some means to verify that it has not been altered in an unauthorized manner before execution.

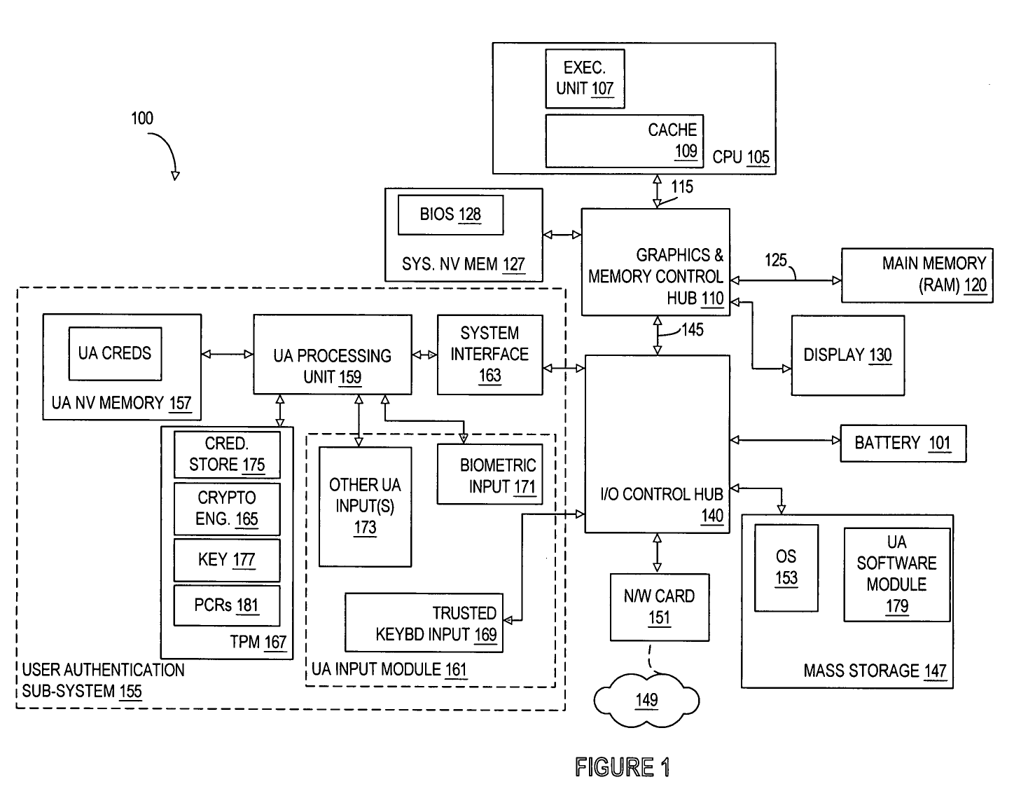

FIG. 1 is a block diagram of a computing system 100 that may advantageously implement the user authentication capabilities according to one or more embodiments. The computing system 100 may, for example, be a mobile computing system such as a notebook or laptop computer. Alternatively, the computing system 100 may be a different type of computing or electronic system such as a desktop computer, a workstation computer, a personal digital assistant, a wireless telephone, a set-top box, or another type of computing device.

Where the computing system 100 is a mobile computing system, a battery and/or battery connector 101 may be included and coupled to the system 100 in a conventional manner to provide an alternate power source for the computing system 100 when, for example, an alternating current power source is not available or convenient.

The computing system 100 includes a central processing unit (CPU or processor) 105 coupled to a graphics and memory control hub (GMCH) or other graphics and/or memory controller 110 via a processor bus 115; a main memory 120, which may comprise, for example, random access memory (RAM) or another type of memory, coupled to the GMCH 110 over a memory bus 125; system non-volatile memory 127 coupled to the GMCH 110 to store a system basic input/output system (BIOS) 128; a display 130 coupled to the GMCH 110; and an input/output (I/O) control hub (ICH) or other I/O controller 140, which may be coupled to the GMCH 110 over a bus 145.

The processor 105 of one embodiment may be an Intel® architecture microprocessor available from Intel Corporation of Santa Clara, Calif. For other embodiments and/or other types of systems, the processing unit 105 may be another type of processing unit such as, for example, an embedded processor, a digital signal processor, a microprocessor from a different source and/or having a different architecture and/or more than one processor may be included. The processor 105 may include an execution unit 107, one or more on-chip and/or off-chip cache memories 109 and other functional units (not shown).

For some embodiments, the processor 105 may be an Intel architecture microprocessor that implements a technology, such as Intel Corporation's Lagrande technology (also referred to herein as LT), that provides for protected execution along with other security-oriented features. Some details of Lagrande technology may currently be found, for example, at http://www.extremetech.com/article2/0,3973,1274197,00.asp. For other embodiments, the CPU 105 may implement a different architecture and/or security technology that provides for protected execution.

The graphics and memory controller (or GMCH) 110 and the I/O controller (or ICH) 140 may be referred to collectively as the chipset. The chipset may be a logic circuit to provide an interface between the processor 105, the memory 120, and other devices. For one embodiment, the chipset is implemented as one or more individual integrated circuits as shown in FIG. 1, but for other embodiments, the capabilities of the chipset may be implemented as a portion(s) of a larger integrated circuit or as parts of multiple other integrated circuits. Also, for some embodiments, the graphics controller may be implemented separately from the memory controller. Although individually labeled herein as a graphics and memory controller and I/O controller, these labels should not be read as a limitation on how the chipset features may be physically implemented.

In addition to the battery 101, a mass storage device 184, such as, for example, a compact disc read-only drive and associated media 147 may also be coupled to the ICH 140. While only one mass storage reference block 147 is shown in FIG. 1, it will be appreciated that multiple mass storage devices of various types may be used to implement the mass storage device 147. Further, additional storage devices may be accessible by the computing system 100 over a network 149 that may be accessed via a network card, modem or other wired or wireless communications device 151, for example.

The computing system 100 may further run an operating system 153. The operating system 153 may be any type of operating system such as, for example, a Windows operating system from Microsoft Corporation of Redmond, Wash., a Linux operating system or another type of operating system.

For other embodiments, the operating system 153 may provide for protected and open partitions and for protected execution of particular software. For example, the operating system 153 may incorporate Microsoft's Next-Generation Secure Computing Base (NGSCB) technology or another technology that provides for protected execution. In particular, such an operating system may be advantageously used for embodiments for which the processor 105 includes security technology as described above.

While the operating system 153 is shown as being stored on the mass storage device 147, all or part of the operating system 153 may be stored in another storage device on, or accessible by, the computing system 100.

To perform user authentication according to various embodiments, the computing system 100 further includes a user authentication sub-system 155. The user authentication sub-system 155 of one embodiment is an operating system-independent, autonomous sub-system of the computing system 100 tasked with enrolling a user and subsequently matching enrollment data with a new request for system and/or resource access.

The user authentication sub-system 155 of one embodiment includes a separated user authentication non-volatile memory 157, a user authentication (UA) processing unit 159, a user authentication input module 161, a system interface 163, and a cryptographic engine 165, which may be provided, for example, as part of a trusted platform module 167. For other embodiments, the cryptographic engine 165 may be a separate unit or may be part of another integrated circuit in the system 100.

The separated user authentication non-volatile memory 157 is referred to as being separated because it is not accessible as part of the conventional system 100 non-volatile memory 127. The separated non-volatile memory 157 may be logically or physically separated so long as it is only accessible in conjunction with multi-factor user authentication activities as described herein. The UA non-volatile memory 157 may be any size that accommodates storage of user authentication-related data as described herein. For many embodiments, the UA non-volatile memory 157 may be relatively small such that relatively little additional silicon real estate is required.

The user authentication processing unit 159 may be any type of processing unit that is capable of performing the user authentication-related processing described herein. For example, the processing unit 159 may be a digital signal processor, an embedded processor or a low horsepower microprocessor, for example. Other types of processing units are within the scope of various embodiments.

While the processing unit 159 of FIG. 1 is illustrated as being a separate processing unit from the CPU 105, for embodiments for which a protected execution environment is provided as described above, the host CPU 105 may be used to handle the processing for the user authentication needs and is considered to be included in the UA sub-system 155. For such embodiments, the separate processing unit 159 may not be included.

With continuing reference to FIG. 1, the user authentication input module 161 may include one or more of a variety of input modules. For the example system of FIG. 1, the input module 161 may include (or use the capabilities of) a trusted keyboard input 169, one or more biometric inputs 171 such as, for example, a fingerprint sensor, an iris sensor, a digital camera for face image capture, and/or another type of biometric capture device, and/or one or more other inputs 173.

For the example system 100 of FIG. 1, the trusted keyboard input 169 may be used for other general purpose computing functions. For other embodiments, the trusted keyboard may be coupled directly to the user-authentication sub-system for keystroke tracking, for example.

For some embodiments, the keyboard 169 may be considered to be a trusted keyboard because a trusted path is provided between the keyboard 169 and trusted software. An example of such a trusted keyboard path is described in copending patent application Ser. No. 10/609,828 entitled, “Trusted Input for Mobile Platforms Transactions,” filed Jun. 30, 2003 and assigned to the assignee of the present invention. Other approaches for providing a trusted path, including providing for encrypted transmissions, are within the scope of various embodiments.

Where provided, the other UA input module(s) 173 may include one or more other types of input modules such as, for example, a stylus input, a camera for facial recognition and/or a smart card, Universal Serial Bus (USB) security token and/or Subscriber Identity Module (SIM) card reader. Other types of authentication data input devices may be included in the UA input module 161 for various embodiments.

The system interface 163 may include the logic necessary to provide an interface between the user authentication sub-system 155 and a particular bus such as a low pin count (LPC) bus, a Universal Serial Bus (USB) or another type of bus.

The cryptographic engine 165 may by any type of cryptographic engine that provides a desired level or type of encryption for the described user authentication activities. Where the cryptographic engine 165 is part of a hardware token such as a Trusted Platform Module (TPM) 167, the TPM may be in accordance with a currently available or future revision of the TPM specification, currently version 1.2 available via the Trusted Computing Group (TCG).

The TPM 167, while shown in FIG. 1 as being coupled directly to the UA processing unit 159 and fully contained within the UA sub-system 155, may alternatively be coupled to the ICH 140 over, for example, a low pin count (LPC) bus. For such embodiments, the TPM 167 may also be used for other purposes.

For one embodiment, the hardware token 167 is a discrete hardware device that may be implemented, for example, using an integrated circuit. For another embodiment, the hardware token 167 may be virtualized, i.e. it may not be provided by a physically separate hardware chip on the motherboard, but may instead be integrated into another chip, or the capabilities associated with a TPM or other hardware token as described herein may be implemented in another manner.

In addition to the cryptographic engine 165, the TPM 167 of one embodiment may include a credential store 175, which may comprise non-volatile memory, to store password and credential information associated with the system 100 and one or more keys 177, which may be include an embedded key to be used for specific encryption, decryption and/or validation processes. For some embodiments, the separated user authentication non-volatile memory may be provided by the credential store 175 as part of the TPM 167 and the separate NV memory 157 may not be included. The TPM 167 may further include digital signatures, a hardware random number generator and/or monotonic counters (not shown).

For other embodiments, the TPM 167 may not be included and/or the cryptographic engine 165 may be provided elsewhere in the system. For example, the cryptographic engine 165 may be implemented as part of another integrated circuit device or may be implemented in software or firmware.

It will be appreciated that, for other embodiments and/or for different types of electronic systems, the system configuration may be different from the exemplary computing system 100.

The user authentication approach of some embodiments is now described in reference to FIGS. 1, 2 and 3. The user authentication approaches of various embodiments may be used to authenticate a user prior to granting access to resources accessible via the host system 100. Examples of such resources may include applications, data, services, communications links, etc. The resources for which the user authentication approaches of various embodiments may be used may be determined by a system designer, administrator or other personnel.

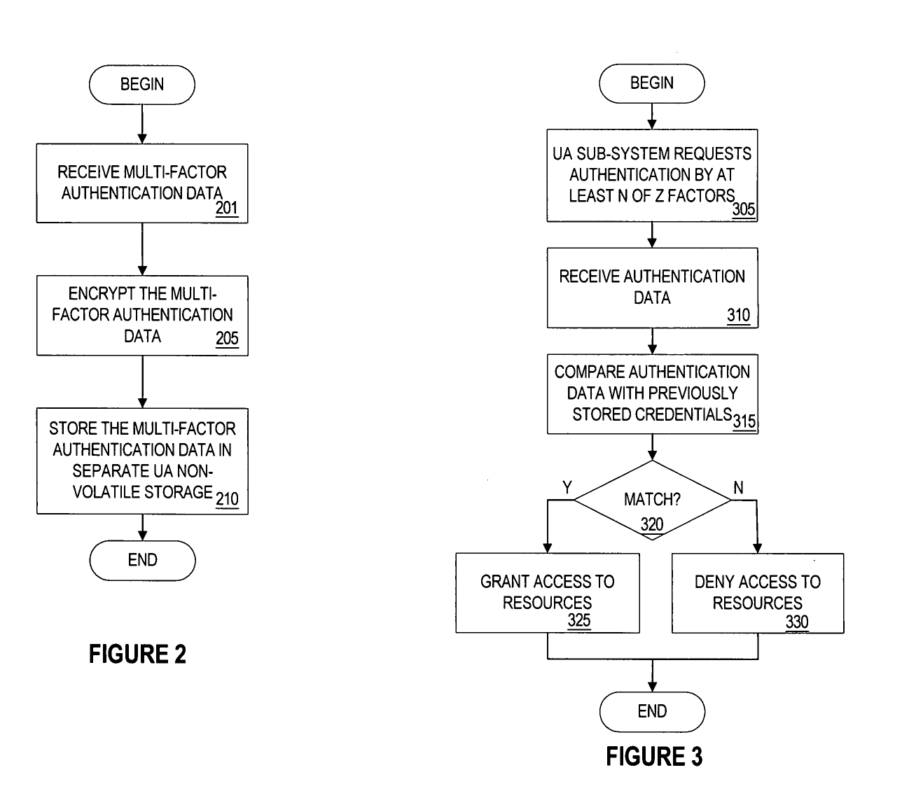

FIG. 2 is a flow diagram showing a method of one embodiment for enrolling a user to enable later user authentication and FIG. 3 is a flow diagram showing a method of one embodiment for subsequently authenticating a user. In describing the methods of FIGS. 2 and 3, reference is made to elements of FIG. 1 for purposes of illustration. It will be appreciated, however, that the particular elements of FIG. 1 are not necessarily needed to practice the embodiments of FIGS. 2 and/or 3.

Referring to FIGS. 1 and 2, at a first time, such as at system genesis-boot, or subsequent reconfiguration under administrator control, multi-factor authentication data associated with Z authentication factors, where Z may be any integer greater than 1, is received at block 201. The multi-factor authentication data is associated with the identity of a particular user. Multiple authorized users may be enrolled at block 201 for some embodiments, particularly where the system of interest provides an enterprise resource, for example. The term “multi-factor” in reference to authentication data refers to the fact that the authentication data is a combination of multiple types of authentication data. Examples may include, but are not limited to, fingerprint data from one or more fingers, iris data, handwriting data, typewriting analysis data, facial recognition data, long passwords, providing a smart card containing user credentials, etc.

The multi-factor authentication data may be received in response to a request provided via an output device such as the display 130 under the control of a user authentication software control module 179, which may be provided as part of the operating system 153, in conjunction with application software (not shown) or in another manner. While the user authentication software control module 179 is shown as being stored on mass storage 147, it will be appreciated that the software control module may be stored in main memory 120 or any other storage device on the system 100.

The multi-factor authentication data may be received via one or more input devices such as the keyboard 169, the biometric input device(s) 171 and/or the other UA input(s) 173 as described above. Biometric data may be captured and stored as a template, for example, in accordance with well-known techniques. Although not the typical practice, the biometric data captured in 201 may alternatively be stored in its original image format, but most commonly should be stored as a reduced representation of the original biometric image.

At block 205, the captured multi-factor authentication data is encrypted. For one embodiment, the data is encrypted/protected by the cryptographic engine 165.

The encrypted multi-factor authentication data may then be stored in the separated user authentication non-volatile memory 157 for the system 100 of FIG. 1 at block 210.

Once a user's credentials have been stored, the user may be authenticated for subsequent access to protected resources.

Referring now to FIGS. 1 and 3, a method of one embodiment for subsequently authenticating a user is described. When a previously enrolled user wants to access the computing system, computing system resources or predetermined applications, or associated enterprise resources, such as when the computing system 100 boots, for example, the user authentication sub-system 155 validates the user against previously stored credentials.

At block 305, the user authentication sub-system 155 requests user authentication by N of the Z previously configured data types, where N is less than or equal to Z. For example, if 4 data types were entered for a particular user at enrollment, 2 data types may be requested for authentication. In this manner, if any of the authentication factor methods or mechanisms is lost, broken, damaged or otherwise unavailable, a user may still be authenticated using a subset of the stored multi-factor authentication data.

At block 310, the authentication data is received. The same template creation process used at processing block 201 of FIG. 2 may be used at block 310 for the newly captured data. At block 315, the authentication data is compared to the credentials previously stored in the secure non-volatile data store 130. This comparison may be performed by the processing unit 159. It will be appreciated that, in order to compare the authentication data to the previously stored credentials, the stored credentials may first be decrypted by the cryptographic engine 165.

At block 320, it is determined whether the authentication data received matches the associated stored credentials. For the system 100, this action may be performed by the user authentication processing unit 159. Given that N of Z authentication credentials have been successfully presented and matched against previously stored data, then at block 325, access to requested system resources is granted. If the authentication data for N of Z credentials does not match the previously stored associated credentials, then at block 330, access to the system resources is denied.

The capabilities of the user authentication sub-system of various embodiments may be requested in a variety of ways. For example, the user authentication sub-system 155 may be requested by BIOS 128 during Power-On-Self-Test (POST) to authenticate a user prior to continuing system start-up. Alternatively, or additionally, the sub-system 155 may be called by the operating system 153 to validate a user. Other applications or environments may also perform user authentication using this secure sub-system.

For some embodiments, to improve security, it may be desirable to bi-laterally authenticate the system 100 and the sub-system 155 prior to allowing them to interact. For such embodiments, the system 100 and sub-system 155 may exchange key pairs during genesis configuration, for example. The user authentication sub-system 155 may encrypt and store its key information in the user authentication non-volatile memory 157 or in the TPM 167, for example. The system 100 may store its key information as data encrypted either through the crypto engine 165 or through protected encryption algorithms within the OS 153 as executed on the host CPU 105, which data is subsequently stored in some type of system non-volatile memory 127 or on the system mass storage device 147.

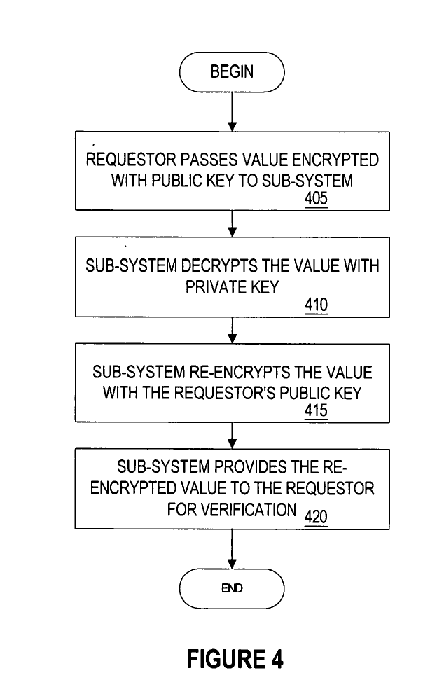

For subsequent validation for such embodiments, referring to FIG. 4, the user authentication sub-system requester (e.g. an application, operating system, BIOS, etc.) passes an encrypted value to the sub-system 155 that has been encrypted with the sub-system's public key at block 405. The sub-system 155 decrypts the value with its own private key at block 410, re-encrypts the value with the requestor's public key at block 415, and passes the value back to the requestor at block 420. Using this approach, the requestor may verify that the sub-system 155 is not a fake and therefore, additional protections against attacks are provided. A similar process may also be performed by the sub-system to verify that the requester is legitimate.

Once the system and user authentication sub-system have validated each other, the sub-system can return a “yes” or “no” response to a request from the requestor to validate a user. It will be appreciated that, for security reasons, the response may be padded with other data, digitally signed for authenticity through well known methods, and/or encrypted to further secure the system.

For some embodiments, to provide additional security, sub-system 155 functionality may be tied to Platform Configuration Registers (PCRs) 181, which may be included in system 100 for some embodiments. The PCRs 181 may be in accordance with the definition provided by the Trusted Computing Platform Alliance (now covered by the Trusted Computing Group), for example. For such embodiments, the PCRs 181 may be referenced prior to user authentication to determine whether the platform configuration has changed. If so, then the UA sub-system 155 may be configured to not even try to validate a user. Using this approach, if portions of a system are changed in an unauthorized manner, access can be denied.

Additionally, for some embodiments, the UA sub-system 155 may provide for backup/restore to a secure media such that user authentication data can be stored for a later restore. In this manner, if a system is damaged or there is otherwise a need to transition to a new computing system, authentication data may be preserved.

For such embodiments, stored authentication credentials may be further encrypted with a password, for example, and provided to media to be installed on a new machine. A handshake or other protection mechanism between the new and old machines may be set up after authenticating a user, such that the authentication credentials may not be easily stolen.

The operating system-independent, autonomous user authentication sub-system of various embodiments may provide for both pre-boot and operating system-present authentication as described above. Using the multi-factor authentication approaches of some embodiments, security may be improved for some applications versus currently implemented approaches.

Thus, various embodiments of a method and system for user authentication are described. In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A system comprising:
at least a first input mechanism to receive first multi-factor authentication data associated with Z authentication factors;
a cryptographic engine to encrypt the first multi-factor authentication data;
a separated user authentication, non-volatile data store to store the encrypted first multi-factor authentication data; and
a first processing unit to determine whether second authentication data received via the at least first input mechanism matches a subset of the first multi-factor authentication data, the second authentication data associated with N authentication factors where N is less than or equal to Z.

2. The system of claim 1 wherein the first input mechanism includes at least one biometric input mechanism.

3. The system of claim 1 further including
a Trusted Platform Module, the cryptographic engine being included in the Trusted Platform Module.

4. The system of claim 1 wherein the first processing unit is one of a microprocessor, a digital signal processor, and an embedded processor.

5. The system of claim 4 wherein the first processing unit implements a security technology to provide for protected execution.

6. The system of claim 4 further including a second processing unit separate from the first processing unit.

7. A system comprising:
a first processor to execute instructions;
a first non-volatile memory to store instructions to be executed by the processor;
a bus coupled to the processor and the first non-volatile memory to communicate information; and
a user authentication sub-system coupled to the bus, the user authentication sub-system including:
a user authentication input module to receive first user authentication data;
a second, separated non-volatile memory to store an encrypted version of the first user authentication data; and
a second user-authentication processor to determine whether second user authentication data matches at least a corresponding subset of the first user authentication data.

8. The system of claim 7 wherein the user authentication sub-system further includes
a cryptographic engine to encrypt the first user authentication data prior to storage.

9. The system of claim 8 wherein the cryptographic engine is included in a trusted platform module.

10. The system of claim 7 wherein the user authentication input module is to receive first authentication data including at least one biometric authentication factor.

11. The system of claim 10 wherein the first authentication data includes Z authentication factors and the second authentication data includes N authentication factors where N is less than Z.

12. The system of claim 7 wherein the second non-volatile memory is physically separated from the first non-volatile memory.

13. The system of claim 7 wherein the second non-volatile memory is logically separated from the first non-volatile memory.

14. A method comprising:
receiving first multi-factor authentication data at a user-authentication sub-system;
decrypting second multi-factor authentication stored in a separated non-volatile memory; and
determining whether the first multi-factor authentication data matches at least a corresponding subset of the second multi-factor authentication data.

15. The method of claim 14 further comprising:
granting access to a resource if the first multi-factor authentication data matches at least a corresponding subset of the second multi-factor authentication data; and
denying access to the resource if the first multi-factor authentication data does not match at least a corresponding subset of the second multi-factor authentication data.

16. The method of claim 15 further comprising:
requesting the first multi-factor authentication data in response to an attempt to access the resource.

17. The method of claim 14 wherein receiving first multi-factor authentication data includes receiving at least one biometric data input type.

18. The method of claim 14 further comprising
receiving the second multi-factor authentication data;
encrypting the second multi-factor authentication data; and
storing the second multi-factor authentication data in the separated, non-volatile memory.

19. The method of claim 14 wherein
determining whether the first multi-factor authentication data matches at least a corresponding subset of the second multi-factor authentication data includes using an authentication processor separate from a main processor.

20. A method comprising:
generating at a requestor a request to authenticate a user;
performing a bi-lateral authentication process to bi-laterally authenticate a user authentication sub-system and the requestor; and
authenticating a user with the user authentication sub-system prior to granting access to a resource if the sub-system and the requestor are bi-laterally authenticated.

21. The method of claim 20 wherein performing the bi-lateral authentication process includes exchanging data encrypted with previously exchanged keys.

22. The method of claim 20 wherein authenticating a user with the user authentication sub-system includes authenticating a user with an operating system-independent user authentication sub-system.

23. A method comprising:
in response to receiving a request for user authentication, checking a platform configuration register to determine if a platform configuration has changed since a previous time the platform configuration register was checked; and
performing a user authentication process with a user authentication sub-system only if it is determined that the platform configuration has not changed.

24. The method of claim 23 wherein performing the user authentication process with the user authentication sub-system includes
receiving first multi-factor authentication data at the user authentication sub-system;
decrypting second multi-factor authentication stored in a separated non-volatile memory; and
determining whether the first multi-factor authentication data matches at least a corresponding subset of the second multi-factor authentication data.

25. The method of claim 24 wherein receiving first multi-factor authentication data includes receiving at least one biometric data type.

26. The method of claim 24 further comprising
controlling access to a resource based on whether the first multi-factor authentication data matches at least a corresponding subset of the second multi-factor authentication data.

27. The method of claim 26 wherein controlling access to a resource includes controlling access to at least one of an enterprise resource, an application and a computer system.

28. A machine-accessible storage medium storing data that, when accessed by a machine, causes the machine to perform a method including:
requesting an autonomous user authentication sub-system to perform a user authentication process;
requesting a user to provide first multi-factor authentication data; and
determining whether to grant access to a resource based on whether the user authentication sub-system determines that the first multi-factor authentication data matches at least a corresponding subset of second multi-factor authentication data encrypted and stored in a separated non-volatile memory of the sub-system.

29. The machine-accessible storage medium of claim 28 wherein requesting the user to provide first multi-factor authentication data includes requesting at least one biometric input data type.
